(19) United States
(12) Patent Application Publication
(10) Pub. No.: US 2022/0335079 A1
(43) Pub. Date: Oct. 20, 2022

(54) METHOD FOR GENERATING VIRTUAL IMAGE, DEVICE AND STORAGE MEDIUM

(71) Applicant: BEIJING BAIDU NETCOM SCIENCE TECHNOLOGY CO., LTD., Beijing (CN)

(72) Inventor: Haotian Peng, Beijing (CN)

(73) Assignee: BEIJING BAIDU NETCOM SCIENCE TECHNOLOGY CO., LTD., Beijing (CN)

(21) Appl. No.: 17/810,746

(22) Filed: Jul. 5, 2022

(30) Foreign Application Priority Data
Jul. 5, 2021 (CN) 202110757279.8

(51) Int. Cl. G06F 16/53; G10L 15/26; G06F 40/205; G06F 40/30

(52) U.S. Cl. CPC G06F 16/53; G10L 15/26; G06F 40/205; G06F 40/30

(57) ABSTRACT

The disclosure provides a method for generating a virtual image, a device and a storage medium. The method includes: receiving a user's speech command comprising a description of a virtual image to be generated; extracting semantic information of the speech command; and obtaining a virtual image corresponding to the semantic information.

### CROSS-REFERENCE TO RELATED APPLICATION

This application claims priority to Chinese Patent Application No. 202110757279.8 filed on Jul. 5, 2021, the disclosure of which is hereby incorporated by reference in its entirety.

### TECHNICAL FIELD

The disclosure relates to the technical field of artificial intelligence, in particular to the technical fields of computer vision, augmented reality, and natural language processing.

### BACKGROUND

Virtual images are widely used in social, live broadcast, games and other character modeling scenarios. In the future augmented reality systems, virtual image will be the main bearing method of human-computer interaction.

### SUMMARY

According to embodiments of the disclosure, a method for generating a virtual image is provided. The method includes:

receiving a user's speech command including a description of a virtual image to be generated;

extracting semantic information of the speech command; and

obtaining a virtual image corresponding to the semantic information.

According to embodiments of the disclosure, an electronic device is provided. The electronic device includes: at least one processor and a memory communicatively coupled to the at least one processor. The memory stores instructions executable by the at least one processor, and when the instructions are executed by the at least one processor, the method for generating a virtual image according to the first aspect of the disclosure is implemented.

According to embodiments of the disclosure, a non-transitory computer-readable storage medium having computer instructions stored thereon is provided. The computer instructions are configured to cause a computer to implement the method for generating a virtual image according to the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a method for generating a virtual image according to an embodiment of the disclosure.

FIG. 2 is a flowchart of pre-establishing a correspondence between semantics and images according to an embodiment of the disclosure.

FIG. 3 is a flowchart of obtaining semantic information matching with a text based on a preset semantic database according to an embodiment of the disclosure.

FIG. 4 is a schematic diagram of application of the method for generating a virtual image according to an embodiment of the disclosure.

FIG. 5 is a block diagram of an apparatus for generating a virtual image according to an embodiment of the disclosure.

FIG. 6 is a block diagram of an apparatus for generating a virtual image according to an embodiment of the disclosure.

FIG. 7 is a block diagram of an apparatus for generating a virtual image according to an embodiment of the disclosure.

FIG. 8 is a schematic diagram of an electronic device for implementing the method for generating a virtual image according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

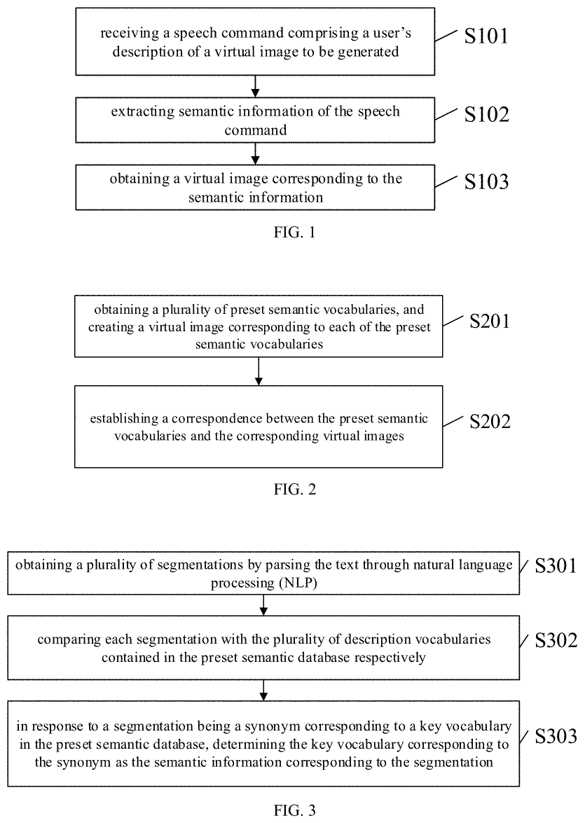

The embodiments of the disclosure provide a method for generating a virtual image. As shown in FIG. 1, the method includes the following steps.

In S101, a speech command including a user's description of a virtual image to be generated is received.

In S102, semantic information of the speech command is extracted.

In S103, a virtual image corresponding to the semantic information is obtained.

In the embodiments of the disclosure, after the speech command is received, the semantic information of the speech command can be extracted. Based on the semantic information, the virtual image corresponding to the semantic information is finally obtained. In this way, the user can obtain the virtual image to be generated only by sending the speech command, and the virtual image is generated through speech interaction, which can reduce interaction cost in the process of generating the virtual image.

At the same time, hands of the user can be liberated, and a virtual image can also be obtained for scenarios in which it is inconvenient for the user to manually operate, which expands application scenarios of the virtual image generation.

The method for generating a virtual image according to the embodiments of the disclosure may be applied to an electronic device, or may also be applied to a system including multiple servers.

As illustrated in FIG. 1, the method for generating a virtual image according to the embodiments of the disclosure can include the following steps.

In S101, a speech command is received.

The speech command includes a description of a virtual image to be generated of a user.

The virtual image is generally an image of a person, and the speech command may include the user's description of the person. For example, the speech command may include description of appearances of the person, such as, big eyes, high nose bridge, white skin, red lips, beautiful, sexy, and cool. Moreover, the speech command may include description of actions of the person, for example, description of facial expressions of the person, or, the speech command include both the description of the appearances of the person and the actions of the person.

The user can send the speech command through a client.

In S102, semantic information of the speech command is extracted.

The semantic information is obtained by performing semantic understanding on the speech command.

The speech command can be converted into a text at first, and then the corresponding semantic information is obtained through natural language processing (NLP).

The speech command can be converted into a text, and the semantic information matching the text is obtained based on a preset semantic database.

In some embodiments, the preset semantic database may be established in advance. The preset semantic database may include a plurality of preset vocabularies, and the preset vocabularies may include vocabularies describing the virtual image.

Firstly, the text can be parsed through NLP, and then the parsed content can be matched with the description vocabularies included in the preset semantic database.

The parsed contents may be a plurality of vocabularies obtained according to natural language understanding rules such as part of speech and sentence sequence.

Matching the parsed contents with the description vocabularies included in the preset semantic database may include following. Each segmentation obtained in the parsed contents is matched with the description vocabularies stored in the preset semantic database. For one segmentation, the segmentation is compared with the description vocabularies sequentially, if the segmentation is included in the description vocabularies, it is understood that the segmentation is a segmentation matching the preset semantic database. In this way, all the segmentations matching the preset semantic database can be combined to obtain the semantic information matching with the text.

Generally, a desired virtual image is described by nouns and adjectives. In one case, nouns and adjectives can be selected out based on the part of speech of each segmentation, and the nouns and adjectives in the parsed contents can be compared with the description vocabularies stored in the preset semantic database. The specific comparison may refer to the above comparison method for the segmentation. In this case, part of the segmentations are selected for comparison, which can improve the efficiency of obtaining the semantic information.

For example, the text converted based on the speech command is “I want a robust girl with double ponytails who looks like XX”, in which “XX” can be the name of a star. The parsed contents obtained by parsing is “I/ want/ a/ robust/ girl/ with/ double-ponytail/ who/ looks/ like/ XX/”. If there are three vocabularies “big eyes”, “high nose bridge” and “double ponytails” in the preset semantic database, each segmentation in the parsed contents is compared with the description vocabularies in the preset semantic database. The segmentation “double ponytails” in the parsed contents exists in the preset semantic database, and the “double ponytails” is the obtained semantic information. If there are four vocabularies “robust”, “high nose bridge”, “double ponytails” and “XX” in the preset semantic database, each segmentation in the parsed contents is compared with the description vocabularies in the preset semantic database respectively. The segmentations “robust”, “double ponytails” and “XX” exist in the preset semantic database, then “robust”, “double ponytails” and “XX” together constitute the semantic information.

The preset semantic database can include as many possible descriptions for a virtual object as possible, and the semantic information corresponding to the speech command can be quickly obtained through the preset semantic database. The preset semantic database can be used as a reference to improve the accuracy of the extracted semantic information.

After the semantic information is obtained, the semantic information can be returned to the user, so that the user can determine whether the semantic understanding is accurate. After it is confirmed that the semantic understanding is accurate, a confirmation instruction is issued, such as a voice reply “the understanding is correct”. The electronic device or a server in a system continues subsequent steps after receiving the confirmation instruction. In this way, user confirmation is involved in the process of semantic understanding, improving the accuracy of the extracted semantic information.

In some embodiments, based on the preset semantic database, it is possible that the semantic information matching the text cannot be obtained, and it can be understood that the semantic information corresponding to the speech command has not been successfully extracted, which means that all the segmentations do not exist in the preset semantic database after each segmentation obtained by text parsing is compared with the description vocabularies stored in the preset semantic database. In the embodiments of the disclosure, if no semantic information matching the text is obtained based on the preset semantic database, a prompt message is returned.

The prompt message can be any form of prompt message, such as text, a speech or a bullet comment. The specific content of the prompt message can be preset, such as “semantics are not extracted successfully”.

The prompt message is configured to inform the user that the semantic information corresponding to the speech command is not successfully extracted based on the preset semantic database. After receiving the prompt message, the user can re-input the speech command. In this way, it is possible to better interact with the user and improve the user experience.

In S103, a virtual image corresponding to the semantic information is obtained.

The virtual image corresponding to the semantic information can be obtained based on an image database. The image database includes a correspondence between a plurality of preset semantic vocabularies and virtual images.

A virtual image may be generated based on a plurality of preset semantic vocabularies and stored in the image database, and a correspondence between the semantics and the image can be established. The correspondence can be understood as a mapping relationship. In this way, after the semantic information is obtained, the virtual image corresponding to the semantic information can be directly obtained from the image database based on the semantic information, which can improve the efficiency of generating the virtual image.

The virtual images corresponding to a plurality of preset semantic vocabularies can be stored in the image database, and the preset semantic vocabularies in the image database can be exactly the same as the description vocabularies in the semantic database, or the preset semantic vocabularies in the image database can be part of the description vocabularies in the semantic database. The process of establishing the image database will be described in detail below, which will not be repeated here.

In the embodiments of the disclosure, the user only needs to send the speech command to obtain the virtual image, so that the virtual image is generated through speech interaction, without the need for the user to manually click the screen for multiple times. For example, it is not necessary for the user to sequentially select the images corresponding to face, hairstyle, eyebrows, eyes, nose, mouth, coat and pants on a selection interface, to obtain a final and complete virtual image based on the images corresponding to each part selected by the user. The embodiments of the disclosure can reduce the interaction cost in the virtual image generation process, which can also be understood as reducing interaction complexity of the virtual image generation process.

In some embodiments, the types of the description vocabularies included in the preset semantic database may be description type, perception type, and reference type.

The description type can represent intuitive description, for example, vocabularies that clearly describe features of facial organs, such as large eyes, high nose bridge, fair skin and red lips.

The perception type can represent description in terms of perception. For example, there is no clear description of the image, and only adjectives for feelings are given, such as beautiful, sexy, and cool.

The reference type can represent description referring to a celebrity, for example, like a certain star.

The description vocabularies of the description type, the feeling type and the reference type can be classified and stored by types in the preset semantic database. The contents, i.e., each segmentation, obtained by parsing the text corresponding to the speech command is compared with these several types of semantic vocabularies respectively, and the semantic information can be extracted based on these three types of description vocabularies.

For example, the text converted based on the speech command is “I want a robust girl with double ponytails who looks like XX”, the contents obtained by parsing is “I/ want/ a/ robust/ girl/ with/ double ponytails/ who/ looks/ like/ XX”, each segmentation is compared with these three types of description vocabularies respectively, two description vocabularies “girl” and “double-ponytail” of the description type, one description vocabulary “robust” of the perception type and one description vocabulary “XX” of the reference type can be obtained.

It can be understood that the preset semantic database in the embodiments of the disclosure considers various types of descriptions, and can record relatively abundant and comprehensive description vocabularies, so that based on the preset semantic database, in the process of obtaining the semantic information matching the text corresponding to the speech command, the success rate of obtaining the semantic information is improved.

Generally, the virtual image can only be generated through description-type vocabularies. For example, it is necessary to specify the type of eyebrows and the type of eyes. By contrast, in the embodiments of the disclosure, the preset semantic database is constructed based on various types of descriptions, which are not limited to the description-type vocabularies. The virtual image can be generated based on other types of vocabularies, which improves the image generation ability.

In an embodiment, as shown in FIG. 2, the process of establishing the image database according to the embodiment of the disclosure includes the following steps.

In S201, a plurality of preset semantic vocabularies are obtained, and a virtual image corresponding to each of the plurality of preset semantic vocabularies is created.

One preset semantic vocabulary may correspond to one virtual image.

The preset semantic vocabulary represents a description of the image.

The virtual images corresponding to the preset semantic vocabularies may be stored in the image database.

The embodiments of the disclosure do not limit the manner of creating the virtual image corresponding to the preset semantic vocabulary, and any manner that can realize the generation of the virtual image is within the protection scope of the embodiments of the disclosure.

In S202, a correspondence between the preset semantic vocabularies and the corresponding virtual images is established.

In a possible implementation, for each preset semantic vocabulary, the preset semantic vocabulary and the virtual image corresponding to the preset semantic vocabulary can be stored correspondingly. For example, a preset semantic vocabulary and a virtual image corresponding to the preset semantic vocabulary can be stored in a row in a table.

In another possible implementation, the preset semantic vocabulary and the corresponding virtual image can also be stored separately. For example, the preset semantic vocabulary is stored corresponding to a piece of position information, the position information is a storage location of the virtual image in the image database. The text and image data can be stored separately, and the data can be stored and managed in a targeted manner based on the features of different types of data.

In this way, a correspondence between the preset semantic vocabulary and the position information of the virtual image corresponding to the preset semantic vocabulary in the image database can be created, this correspondence is the correspondence between the virtual image corresponding to the preset semantic vocabulary and the preset semantic vocabulary. For example, the correspondence may be a relationship table including the preset semantic vocabularies and the position information in the image database of the virtual images corresponding to the preset semantic vocabularies.

In this way, the virtual images respectively corresponding to the preset semantic vocabularies are created, and the correspondence between the virtual images corresponding to the preset semantic vocabularies and the preset semantic vocabularies is created, that is, the correspondence between semantics and images. In this way, the virtual image corresponding to the semantic information can be obtained directly from the image database based on the semantic information, which can improve the efficiency of generating the virtual image. In the embodiments of the disclosure, the image database includes a plurality of correspondences between the preset semantic vocabularies and the corresponding virtual images, which can support a lot of semantic information to successfully obtain corresponding virtual images based on the image database, and can improve the ability of generating the virtual image.

In an optional embodiment, when the semantic vocabularies included in the semantic database can include the description type, the perception type and the reference type, the types of the preset semantic vocabularies in the image database can also include the description type, the perception type and the reference type. In the process of creating the image database, corresponding virtual images can be created for these different types of preset semantic vocabularies.

In detail, on the basis of the embodiment shown in FIG. 2, S201 may include the following steps.

For the description-type preset semantic vocabulary, the virtual image corresponding to the preset semantic vocabulary is obtained from known virtual images. In detail, in the prior art, the virtual image is generally generated through description vocabularies. In the embodiments of the disclosure, the virtual images corresponding to the existing description vocabularies can be collected, so that the computing amount for creating the virtual image can be reduced.

It can also be understood that semantic annotation is performed on the created image data to generate direct mapping, that is, the virtual image that matches the preset semantic vocabulary of the description type is searched from the created virtual images, and the preset semantic vocabulary of the description type can be directly annotated in the virtual image. In this way, if the description-type preset semantic vocabulary corresponds to the meaning of the annotated virtual image, it can be understood that the correspondence between the description-type preset semantic vocabulary and the virtual image is established.

For the preset semantic vocabulary of the perception type, the virtual image corresponding to the preset semantic vocabulary is created, and a synonym of the preset semantic vocabulary is searched, and the virtual image corresponding to the preset semantic vocabulary is determined as the virtual image corresponding to the synonym.

For example, the preset semantic vocabularies of the perception type include adjectives such as beautiful, sexy and cool, and synonyms corresponding to the adjectives can be collected as many as possible. For example, the synonyms of beautiful are pretty, good-looking, easy on the eyes, attractive, graceful, pleasing to the eyes, gorgeous, elegant and wonderful. In this way, the purpose of expanding language support capabilities can be achieved.

For the preset semantic vocabulary of reference type, the virtual image corresponding to the preset semantic vocabulary is obtained by reconstructing a face corresponding to a reference name.

For example, in a face reconstruction process, a star list can be manually collected, and operation is performed on a virtual image face reconstruction system through a screen of a mobile phone, to distribute the list to a batch of human, and face reconstruction is performed by the human according to photos of the stars in a corresponding distributed sub-list, and the data are saved in the image database uniformly for matching process.

The user's language description of the virtual image is divided into three categories, i.e., the description type, the perception type and the reference type. In the process of pre-creating the virtual images corresponding to the preset semantic vocabularies, the comprehension ability of language is expanded as much as possible under the limited images, which effectively improves the comprehension ability of complex description language. In this way, when the virtual image corresponding to the semantic information is obtained from the image database based on the correspondence between the semantics and the image, the semantic information can be fully understood, and the virtual image corresponding to the semantic information can be accurately obtained.

In an optional embodiment, the preset semantic database may collect as many description vocabularies as possible, and all descriptions may be redirected to a small amount of key description vocabularies. Correspondingly, the image database may include virtual images corresponding to the key description vocabularies, that is, the preset semantic vocabularies included in the image database are the key description vocabularies in the preset semantic vocabularies.

The preset semantic database includes a plurality of description vocabularies, and the plurality description vocabularies include a plurality of key vocabularies and synonyms corresponding to the key plurality vocabularies respectively, the image database includes the virtual images corresponding to the key vocabularies respectively.

As shown in FIG. 3, obtaining the semantic information matching the text based on the preset semantic database includes the following steps.

In S301, a plurality of segmentations are obtained by parsing the text through natural language processing (NLP).

In S302, each segmentation is compared with the plurality of description vocabularies contained in the preset semantic database respectively.

In detail, the processes of parsing the text through NLP to obtain the plurality of segmentations and comparing the segmentation with the description vocabularies respectively has been described in detail in the above embodiments, and will not be repeated here.

In S303, in response to a segmentation being a synonym corresponding to a key vocabulary in the preset semantic database, the key vocabulary corresponding to the synonym is determined as the semantic information corresponding to the segmentation.

Obtaining the virtual image corresponding to the semantic information based on the image database includes: obtaining the virtual image corresponding to the key vocabulary from the image database using the key vocabulary.

In detail, by redirecting all descriptions to a small amount of key description vocabularies, it can be understood that for one key vocabulary, synonyms of the key vocabulary are collected, and the key vocabulary and the synonyms of the key vocabulary are stored correspondingly. For example, pretty, good-looking, easy on the eyes, attractive, graceful, pleasing to the eyes, gorgeous, elegant, wonderful and beauty are all considered as the synonyms of “beautiful”. The preset semantic database determines “beautiful” as a key vocabulary, and all the synonyms of “beautiful” are saved correspondingly to the key vocabulary “beautiful”. For example, “beautiful” and all the corresponding synonyms are saved in one row, and “beautiful” is saved in the first column of this row.

When a segmentation is a key vocabulary, the key vocabulary is the semantic information that matches the text, and the virtual image corresponding to the key vocabulary can be obtained from the image database directly based on the key vocabulary.

When a segmentation is a synonym corresponding to a key vocabulary, the key vocabulary corresponding to the synonym is determined as the semantic information corresponding to the segmentation. Then, the virtual image is found according to the key vocabulary, and the virtual image corresponding to the key vocabulary is determined as the virtual image of the synonym. For example, when a segmentation matches “pretty” or “good-looking”, it can be determined that the key vocabulary corresponding to “pretty” or “good-looking” is “beautiful”. Then the virtual image of “beautiful” can be obtained from the image database, and the virtual image of “beautiful” can be regarded as the virtual image of “pretty” or “good-looking”. That is, although the virtual image of “pretty” or “good-looking” is not saved in the image database, the virtual image of “pretty” or “good-looking” can be obtained based on the preset semantic database and the image database.

In this way, only a small amount of virtual images are stored in the image database, so that the cost of generating virtual images in advance can be reduced. At the same time, correspondence between the plurality of synonyms and the key vocabulary is established, even if the virtual images corresponding to the synonyms are not stored in the image database, the virtual images can be obtained based on the key vocabulary corresponding to the synonyms, to improve the ability of generating the virtual images.

In an optional embodiment, adjustment data corresponding to the semantic information is stored in the image database, and the virtual image corresponding to the semantic information can be obtained by adjusting a default image based on the adjustment data. The adjustment data can be the information of bone nodes that control vertex transformation of a model.

Obtaining the virtual image corresponding to the semantic information may include:

obtaining the adjustment data corresponding to the semantic information, in which the adjustment data is data for adjusting the default image; and

adjusting bone nodes in the default image using the adjustment data to obtain the virtual image corresponding to the semantic information.

In detail, the virtual image is designed based on a skin-bone model, and each bone node in the skin-bone model controls transformation of a part of vertices of the model. For example, the bone nodes of a nose can control appearance of the nose, and the bone nodes of a mouth can control appearance of the mouth. That is, the appearance of each element can be combined through different bone nodes. The skin-bone model belongs to the related art, and other contents of the skin-bone model will not be described here.

Generally, the description vocabularies of the description type can only change the appearance of a single bone node, while the description vocabularies of perception type or reference type usually change the appearance of multiple bone nodes. Simply, when one bone node adjusts the image corresponding to one element, it can be understood that the adjustment data corresponding to the description vocabulary of the description type includes information of a single bone node, so as to adjust a single element based on the default image. The adjustment data corresponding to the description vocabularies of the perception type or the reference type includes information of multiple bone nodes, so as to adjust multiple elements based on the default image. The elements can be understood as parts that constitute a virtual image, for example, various parts of a person's profile, such as face shape, eyebrows, eyes, nose and mouth; and actions of the person, such as facial expressions.

A default image can be stored in the image database, and the default image can be adjusted according to the adjustment data to generate a final virtual image, and adjustment can also be understood as modification.

The default image is adjusted based on the adjustment data to obtain the virtual image, i.e., modification is performed on an existing default image to obtain the virtual image, which can reduce the computing amount. In addition, the image database may have only one default image and multiple pieces of adjustment data stored in the image database without the need to store multiple virtual images, which can reduce the occupation of storage resources.

In some embodiments, a priority order can be set, and the adjustment may be performed according to the priority order.

The priority order may include: a descending order of priorities of the reference type, the perception type, and the description type, or a word order. One of the two orders may be considered, or both orders may be considered.

The descending order of priorities of the reference type, the perception type and the description type can be understood as, in the process of adjustment, the priority of adjustment based on the adjustment data corresponding to the description vocabulary of the reference type is higher than the priority of adjustment based on the adjustment data corresponding to the description vocabulary of the perception type, and the priority of adjustment based on the adjustment data corresponding to the description vocabulary of the perception type is higher than the priority of adjustment based on the adjustment data corresponding to the description vocabulary of the description type.

In a specific example, the preset semantic database includes a vocabulary of description type “big eyes”, a vocabulary of perception type “beauty” and a correspondence between “beauty” and “good-looking”. The image database stores adjustment data corresponding to the vocabulary of description type “big eyes” and adjustment data corresponding to the vocabulary of perception type “beauty”. The text corresponding to the semantic instruction is “beauty with big eyes”, two segmentations “big eyes” and “beauty” are obtained after parsing. The correspondence between “beauty” and “good-looking” is stored in the preset semantic database, which can be understood that the key vocabulary corresponding to “beauty” is “good-looking”.

The two segmentations obtained after parsing are compared with the preset semantic database, in which both “big eyes” and “beauty” exist in the preset semantic database. At the same time, the key vocabulary “good-looking” corresponding to “beauty” can be obtained. The key vocabulary “good-looking” corresponding to “beauty” is obtained, then it can be understood that the virtual image (the adjustment data of the virtual image to be generated) corresponding to “good-looking” is stored in the image database, but the virtual image corresponding to “beauty” is not saved. Therefore, “good-looking” can be replaced by “beauty” as the obtained semantic information. At this time, the semantic information matched with “beauty with big eyes” includes “big eyes” and “good-looking”.

The adjustment data corresponding to “big eyes” and “good-looking” can be obtained from the image database, firstly, the default image is adjusted based on the adjustment data corresponding to the vocabulary of perception type “good-looking”, and then the adjusted image is further adjusted based on the vocabulary of description type “big eyes”.

The multiple segmentations obtained by parsing the text corresponding to the speech command have a semantic sequential order, and the multiple pieces of semantic information respectively obtained based on the multiple segmentations can also have the semantic sequential order, and the word order can be understood as the semantic sequential order of the semantic information.

In an optional embodiment, the semantic information may include sub-semantic information corresponding to multiple elements respectively.

The elements can be understood as the parts that constitute the virtual image, for example, various parts of a person's profile, such as face shape, eyebrows, eyes, nose and mouth, or can be understood as actions of the person, such as facial expressions.

In an embodiment, obtaining the virtual image corresponding to the semantic information based on the image database includes:

for each element, obtaining a virtual sub-image based on the sub-semantic information corresponding to the element from the image database; and

obtaining the virtual image based on virtual sub-images corresponding to the plurality of elements.

In the process of obtaining the virtual image, the virtual sub-images corresponding to the elements are obtained in units of element, which can more conveniently obtain the virtual sub-images corresponding to the sub-semantic information, to obtain a complete virtual image.

An element may correspond to one or more piece of sub-semantic information. The multiple pieces of sub-semantic information corresponding to one element may include multiple pieces of semantic information of different dimensions, such as big eyes, sharp eyes and amber-color eyes.

In one case, a piece of sub-semantic information is obtained for each element. At this time, the virtual sub-images corresponding to all the sub-semantic information can be combined to obtain the final virtual image, so that the complete virtual image can be easily obtained. Combination can be understood as merging multiple virtual sub-object into one virtual figure.

In another case, the virtual sub-images corresponding to one or more pieces of sub-semantic information obtained for one element are the same. In this case, one virtual sub-image is obtained for each element s, and combining the virtual sub-images of respective elements can be understood as splicing the virtual sub-images of different elements to obtain the complete virtual image.

In another case, for a situation that there are multiple pieces of sub-semantic information for one element, a virtual sub-image corresponding to each piece of sub-semantic information corresponding to the element is obtained based on the correspondence between the sub-semantic information and the element according to the sub-semantic information corresponding to the element. If there is a conflict between the virtual sub-images corresponding to the respective pieces of sub-semantic information, a virtual sub-image corresponding to the sub-semantic information in the latter semantic order is selected as the virtual sub-image corresponding to the element.

An element having multiple pieces of sub-semantic information that conflict with each other mentioned here can be understood as different descriptions of the element in the same dimension, such as big eyes and small eyes. In this case, different virtual sub-images are obtained for each element, which can also be understood as obtaining virtual sub-images that conflict with each other.

According to the actual situation, when there is a conflict, the content in the latter semantic order is generally the content that is actually intended to be expressed. For example, the user first describes the eyebrows, and then the user wants to modify it into another description, then the eyebrows can be parsed to get multiple pieces of sub-semantic information. The semantic information in the latter semantic order is the description that the user actually wants to express.

If the virtual sub-images corresponding to each piece of sub-semantic information is in conflict, then selecting the virtual sub-images corresponding to the sub-semantic information in the latter semantic order as the virtual image corresponding to the element can be understood as selecting the virtual image that is more in line with the user's expression according to the priority order. In this way, the accuracy of the virtual image can be improved. At the same time, when the user wants to modify the previous description, the user only needs to say the modified description without performing additional operations, which can further reduce the complexity of user interaction and improve the user experience.

After obtaining the virtual image, the virtual image can be sent to the client, so that the client can render and display the virtual image.

The method for generating a virtual image according to the embodiments of the disclosure can be applied to a system including multiple servers, i.e., the method for generating a virtual image is implemented by multiple servers together.

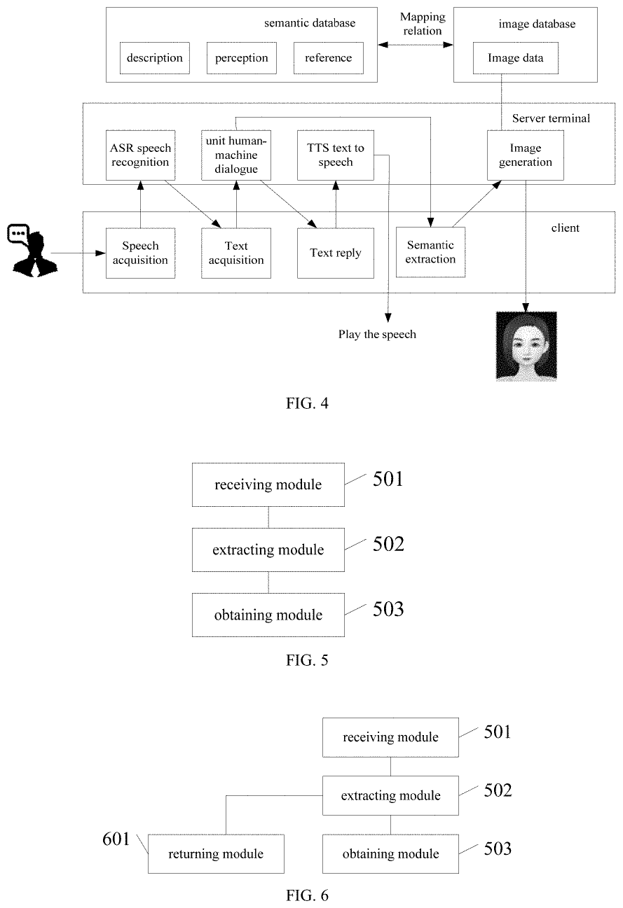

FIG. 4 is an application schematic diagram of applying the method for generating a virtual image according to an embodiment of the disclosure. The server side interacts with the client side to implement the method for generating a virtual image according to the embodiments of the disclosure. In detail, the server side may include an automatic speech recognition (ASR) recognition terminal, a unit human-machine dialogue terminal, a text-to-speech terminal, and an image generation terminal. These parts included in the server side can be understood as different modules of an electronic device, or it can be implemented by different servers, such as an automatic speech recognition server, a unit human-machine dialogue server, a text-to-speech (TTS) server and an image generation server.

The client obtains a speech sent by the user, and sends the speech to the ASR server, so that the ASR server can receive the speech, i.e., receiving the speech command.

The ASR server performs language analysis on the speech through ASR speech recognition, to convert the speech into a text, and sends the text to the client, so that the client sends the text to the unit human-machine dialogue terminal.

The unit human-computer dialogue terminal performs semantic extraction on the text, to obtain the semantic information matching the text, and sends the extracted semantic information to the client. The client sends the semantic information to the image generating terminal, and the image generating terminal obtains the virtual image corresponding to the semantic information from the image database based on the correspondence.

In detail, the following description is given by taking the parts included in the server as different servers as an example.

When the user speaks to the client, the client records and saves the user's speech, i.e., the speech command.

The client sends the user's current speech to the ASR server, and the ASR server performs language analysis on the speech through the ASR speech recognition capability to convert the speech into text. The ASR server returns the text to the client, and the client can display the text corresponding to the speech.

The client receives the text returned by the ASR server and sends the text to the unit human-machine dialogue server.

On the one hand, the unit human-machine dialogue server parses the text through NLP, fills a preset vocabulary slot, and completes the semantic extraction, that is, the above-mentioned process of matching the parsed content with multiple description vocabularies included in the preset semantic database. The above-mentioned process of matching the parsed content with multiple description vocabularies included in the preset semantic database is described in detail in the above embodiments, reference may be made to the above-described steps to implement the semantic extraction, and will not be repeated here. The unit human-machine dialogue server can return the obtained semantic information to the client.

In this way, the client can send the semantic information to the image generation server. A corresponding image is obtained by matching based on the correspondence between the semantics and the images, the multiple matching processes may be ordered according to priority, and non-conflicting image data can be combined. The image generation server returns the virtual image to the client, and the client can render and display the virtual image. The process of obtaining the corresponding image by matching based on the correspondence may refer to the steps of obtaining the virtual image corresponding to the semantic information based on the image database in the above-mentioned embodiments. The detailed process of the step of obtaining the virtual image corresponding to the semantic information based on the image database has been described in detail in the above-mentioned embodiments, which will not be repeated here.

On the other hand, the unit human-machine dialogue server makes judgments according to the semantic information, and feeds back a preset reply according to whether data conditions of the semantic database are satisfied. That is, no semantic information matching the text is obtained based on the preset semantic database, and the reply is a prompt message, which is used to explain to the user that no semantic information matching the text is obtained based on the preset semantic database. At this time, the client can send the reply to the TTS server, and the TTS server gives a speech file of the reply through text-to-speech conversion, and returns the speech file to the client, so that the client can play the speech file. In this way, the user can receive a speech reply.

In addition, when the semantic information is successfully extracted, the reply corresponding to the speech information can also be generated, and the reply corresponding to the speech information is also returned to the client, so that the client can also send the reply corresponding to the semantic information to the TTS server, the TTS server generates a speech file of the reply corresponding to the semantic information. Therefore, the speech file can be played while displaying the virtual image, so that the virtual image and the semantic information can be associated, the virtual image can be created in a richer and three-dimensional manner, thus the user experience is improved.

The embodiments of the disclosure can implement a complete process of one-sentence image generation in an order of user speech input, text, semantics, image generation and machine speech reply. In a word, the generation of the virtual image can be driven by on sentence, and if driving the generation of virtual image appearance by one sentence can be realized, the interaction cost of generating the virtual image can be reduced, and the interaction complexity is reduced. By realizing a breakthrough from zero to one in the direction of virtual image generation from manual click operation to speech interaction, the inherent technical strength of virtual image generation is improved, the application scenarios of products are expanded, product dimensions are enhanced and product brand recognition is improved.

Corresponding to the method for generating a virtual image according to the above embodiments, the embodiments of the disclosure also provide an apparatus for generating a virtual image, as shown in FIG. 5, the apparatus may include: a receiving module 501, an extracting module 502 and an obtaining module 503.

The receiving module 501 is configured to receive a user's speech command comprising a description of a virtual image to be generated.

The extracting module 502 is configured to extract semantic information of the speech command.

The obtaining module 503 is configured to obtain a virtual image corresponding to the semantic information.

In some embodiments, the extracting module 502 is further configured to:

convert the speech command into a text; and

obtain the semantic information matching the text based on a preset semantic database.

In some embodiments, as shown in FIG. 6, the apparatus may further include: a returning module 601, configured to return a prompt message in response to no semantic information matching the text being obtained based on the preset semantic database.

In some embodiments, the obtaining module 503 is configured to obtain the virtual image corresponding to the semantic information based on an image database. The image database comprises a correspondence between a plurality of preset semantic vocabularies and virtual images.

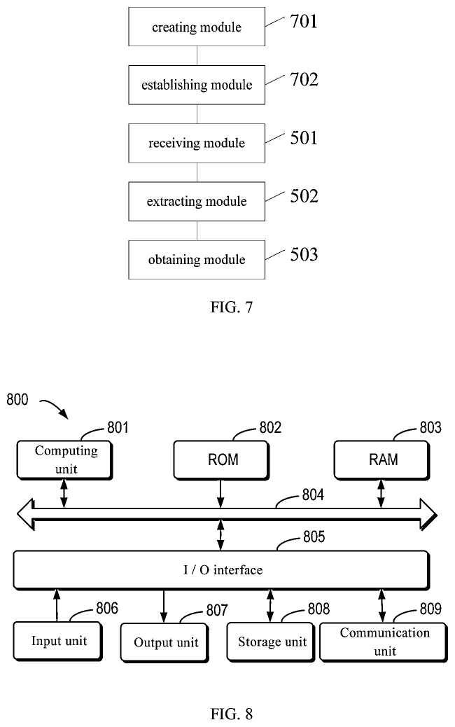

In some embodiments, as shown in FIG. 7, the apparatus may further include: a creating module 701 and an establishing module 702.

The creating module 701 is configured to obtain a plurality of preset semantic vocabularies, and create a virtual image corresponding to each of the preset semantic vocabularies, in which each preset semantic vocabulary represents a description of an image.

The establishing module 702 is configured to establish a correspondence between the preset semantic vocabularies and the corresponding virtual images.

In some embodiments, the preset semantic database includes a plurality of description vocabularies, the plurality of description vocabularies comprise a plurality of key vocabularies and synonyms corresponding to the key vocabularies, and the image database comprises virtual images respectively corresponding to the key vocabularies.

The extracting module 502 is configured to:

obtain a plurality of segmentations by parsing a text through natural language processing (NLP);

compare each segmentation with the plurality of description vocabularies contained in the preset semantic database respectively;

in response to a segmentation being a synonym corresponding to a key vocabulary in the preset semantic database, determine the key vocabulary corresponding to the synonym as the semantic information corresponding to the segmentation.

The obtaining module 503 is further configured to obtain the virtual image corresponding to the key vocabulary from the correspondence from the image database using the key vocabulary.

In some embodiments, the image database has adjustment data corresponding to the semantic information stored therein, the adjustment data is configured to adjust default image to obtain the virtual image corresponding to the semantic information, and the obtaining module 503 is further configured to: obtain the adjustment data corresponding to the semantic information, wherein the adjustment data is data for adjusting the default image; and adjust a bone node in the default image using the adjustment data to obtain the virtual image corresponding to the semantic information.

In some embodiments, the semantic information includes sub-semantic information corresponding to a plurality of elements, and the obtaining module 503 is further configured to:

for each element, obtain a virtual sub-image based on the sub-semantic information corresponding to the element from the image database; and

obtain the virtual image based on virtual sub-images corresponding to the plurality of elements.

The method for generating a virtual image according to the embodiments of the disclosure is applied to an apparatus for generating a virtual image, then all the embodiments of the method for generating a virtual image are applicable to the device, and the same or similar beneficial effects can be achieved.

In the technical solution of the disclosure, the acquisition, storage, and application of the user personal information involved all comply with the provisions of relevant laws and regulations, and do not violate public order and good customs.

According to the embodiments of the disclosure, the disclosure also provides an electronic device, a readable storage medium and a computer program product.

FIG. 8 is a block diagram of an example electronic device 700 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 8, the device 800 includes a computing unit 801 performing various appropriate actions and processes based on computer programs stored in a read-only memory (ROM) 802 or computer programs loaded from the storage unit 808 to a random access memory (RAM) 803. In the RAM 803, various programs and data required for the operation of the device 800 are stored. The computing unit 801, the ROM 802, and the RAM 803 are connected to each other through a bus 804. An input/output (I/O) interface 805 is also connected to the bus 804.

Components in the device 800 are connected to the I/O interface 805, including: an inputting unit 806, such as a keyboard, a mouse; an outputting unit 807, such as various types of displays, speakers; a storage unit 808, such as a disk, an optical disk; and a communication unit 809, such as network cards, modems, and wireless communication transceivers. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of computing unit 801 include, but are not limited to, a central processing unit (CPU), a graphics processing unit (GPU), various dedicated artificial intelligence (AI) computing chips, various computing units that run machine learning model algorithms, and a digital signal processor (DSP), and any appropriate processor, controller and microcontroller. The computing unit 801 executes the various methods and processes described above, such as the method for generating a virtual image. For example, in some embodiments, the method may be implemented as a computer software program, which is tangibly contained in a machine-readable medium, such as the storage unit 808. In some embodiments, part or all of the computer program may be loaded and/or installed on the device 800 via the ROM 802 and/or the communication unit 809. When the computer program is loaded on the RAM 803 and executed by the computing unit 801, one or more steps of the method described above may be executed. Alternatively, in other embodiments, the computing unit 801 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server can be a cloud server, a distributed system server, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for generating a virtual image, comprising:
receiving a speech command comprising a user's description of a virtual image to be generated;
extracting semantic information of the speech command; and
obtaining a virtual image corresponding to the semantic information.

2. The method of claim 1, wherein extracting the semantic information of the speech command comprises:
converting the speech command into a text; and
obtaining the semantic information matching the text based on a preset semantic database.

3. The method of claim 2, further comprising:
returning a prompt message in response to no semantic information matching the text being obtained based on the preset semantic database.

4. The method of claim 2, wherein obtaining the virtual image corresponding to the semantic information comprises:
obtaining the virtual image corresponding to the semantic information based on an image database, wherein the image database comprises a correspondence between a plurality of preset semantic vocabularies and virtual images.

5. The method of claim 1, further comprising:
obtaining a plurality of preset semantic vocabularies, and creating a virtual image corresponding to each of the preset semantic vocabularies, wherein each preset semantic vocabulary represents a description of an image; and
establishing a correspondence between the preset semantic vocabularies and the corresponding virtual images.

6. The method of claim 4, wherein the preset semantic database comprises a plurality of description vocabularies, the plurality of description vocabularies comprise a plurality of key vocabularies and synonyms corresponding to the key vocabularies, and the image database comprises virtual images respectively corresponding to the key vocabularies;
obtaining the semantic information matching the text based on the preset semantic database comprises:
obtaining a plurality of segmentations by parsing the text through natural language processing (NLP);
comparing each segmentation with the plurality of description vocabularies contained in the preset semantic database respectively; and
in response to a segmentation being a synonym corresponding to a key vocabulary in the preset semantic database, determining the key vocabulary corresponding to the synonym as the semantic information corresponding to the segmentation; and
obtaining the virtual image corresponding to the semantic information based on the image database comprises:
obtaining the virtual image corresponding to the key vocabulary from the image database using the key vocabulary.

7. The method of claim 4, wherein the image database has adjustment data corresponding to the semantic information stored therein, the adjustment data is configured to adjust default image to obtain the virtual image corresponding to the semantic information;
obtaining the virtual image corresponding to the semantic information based on the image database comprises:
obtaining the adjustment data corresponding to the semantic information, wherein the adjustment data is data for adjusting the default image; and
adjusting a bone node in the default image using the adjustment data to obtain the virtual image corresponding to the semantic information.

8. The method of claim 4, wherein the semantic information comprises sub-semantic information corresponding to a plurality of elements;
obtaining the virtual image corresponding to the semantic information based on the image database comprises:
for each element, obtaining a virtual sub-image based on the sub-semantic information corresponding to the element from the image database; and
obtaining the virtual image based on virtual sub-images corresponding to the plurality of elements.

9. An electronic device, comprising:
at least one processor; and
a memory communicatively coupled to the at least one processor; wherein,
the memory stores instructions executable by the at least one processor, when the instructions are executed by the at least one processor, the at least one processor is caused to implement a method for generating a virtual image, comprising:
receiving a speech command comprising a user's description of a virtual image to be generated;
extracting semantic information of the speech command; and
obtaining a virtual image corresponding to the semantic information.

10. The electronic device of claim 9, wherein extracting the semantic information of the speech command comprises:
converting the speech command into a text; and
obtaining the semantic information matching the text based on a preset semantic database.

11. The electronic device of claim 10, wherein, the method further comprises:
returning a prompt message in response to no semantic information matching the text being obtained based on the preset semantic database.

12. The electronic device of claim 10, wherein obtaining the virtual image corresponding to the semantic information comprises:
obtaining the virtual image corresponding to the semantic information based on an image database, wherein the image database comprises a correspondence between a plurality of preset semantic vocabularies and virtual images.

13. The electronic device of claim 9, wherein, the method further comprises:
obtaining a plurality of preset semantic vocabularies, and creating a virtual image corresponding to each of the preset semantic vocabularies, wherein each preset semantic vocabulary represents a description of an image; and
establishing a correspondence between the preset semantic vocabularies and the corresponding virtual images.

14. The electronic device of claim 12, wherein the preset semantic database comprises a plurality of description vocabularies, the plurality of description vocabularies comprise a plurality of key vocabularies and synonyms corresponding to the key vocabularies, and the image database comprises virtual images respectively corresponding to the key vocabularies;
obtaining the semantic information matching the text based on the preset semantic database comprises:
obtaining a plurality of segmentations by parsing the text through natural language processing (NLP);
comparing each segmentation with the plurality of description vocabularies contained in the preset semantic database respectively; and
in response to a segmentation being a synonym corresponding to a key vocabulary in the preset semantic database, determining the key vocabulary corresponding to the synonym as the semantic information corresponding to the segmentation; and
obtaining the virtual image corresponding to the semantic information based on the image database comprises:
obtaining the virtual image corresponding to the key vocabulary from the image database using the key vocabulary.

15. The electronic device of claim 12, wherein the image database has adjustment data corresponding to the semantic information stored therein, the adjustment data is configured to adjust default image to obtain the virtual image corresponding to the semantic information;
obtaining the virtual image corresponding to the semantic information based on the image database comprises:
obtaining the adjustment data corresponding to the semantic information, wherein the adjustment data is data for adjusting the default image; and
adjusting a bone node in the default image using the adjustment data to obtain the virtual image corresponding to the semantic information.

16. The electronic device of claim 12, wherein the semantic information comprises sub-semantic information corresponding to a plurality of elements;
obtaining the virtual image corresponding to the semantic information based on the image database comprises:
for each element, obtaining a virtual sub-image based on the sub-semantic information corresponding to the element from the image database; and
obtaining the virtual image based on virtual sub-images corresponding to the plurality of elements.

17. A non-transitory computer-readable storage medium storing computer instructions, wherein the computer instructions are configured to cause a computer to implement a method for generating a virtual image, comprising:
receiving a speech command comprising a user's description of a virtual image to be generated;
extracting semantic information of the speech command; and
obtaining a virtual image corresponding to the semantic information.

18. The non-transitory computer-readable storage medium of claim 17, wherein extracting the semantic information of the speech command comprises:
converting the speech command into a text; and
obtaining the semantic information matching the text based on a preset semantic database.

19. The non-transitory computer-readable storage medium of claim 18, wherein, the method further comprises:
returning a prompt message in response to no semantic information matching the text being obtained based on the preset semantic database.

20. The non-transitory computer-readable storage medium of claim 18, wherein obtaining the virtual image corresponding to the semantic information comprises:
obtaining the virtual image corresponding to the semantic information based on an image database, wherein the image database comprises a correspondence between a plurality of preset semantic vocabularies and virtual images.
